(19) United States
(12) Patent Application Publication
(10) Pub. No.: US 2010/0111478 A1
(43) Pub. Date: May 6, 2010

(54) NON-LINEAR FIBER ARRAY HAVING OPPOSING V-GROOVE STRUCTURES

(75) Inventor: Takaharu Fujiyama, Albany, CA (US)

Correspondence Address: HESLIN ROTHENBERG FARLEY & MESITI PC, 5 COLUMBIA CIRCLE, ALBANY, NY, 12203, US

(73) Assignee: AiDi Corporation, Ibaraki (JP)

(21) Appl. No.: 12/612,108

(22) Filed: Nov. 4, 2009

Related U.S. Application Data
(60) Provisional application No. 61/111,047, filed on Nov. 4, 2008.

(51) Int. Cl. G02B 6/36; G02B 6/26

(52) U.S. Cl. 385/77; 264/1.25; 385/50; 385/89

(57) ABSTRACT

A fiber array unit (FAU) having plurality of optical transmission channels (e.g., fiber optics) terminating at a side surface thereof for carrying optical signals to and/or from waveguides in a planar lightwave circuit (PLC). The optical transmission channels of the FAU terminate at the side surface thereof in a non-linear, cross-sectional pattern (e.g., a curved pattern). The non-linear pattern is determined by a pattern of grooves formed in a substrate of the FAU, in combination with a lid which may also have an inverse, non-linear pattern, to thereby rigidly, reliably and permanently hold the optical transmission channels in place.

### CROSS-REFERENCE TO RELATED APPLICATION

This application claims the benefit of U.S. Provisional Application No. 61/111,047, filed Nov. 4, 2008, which is hereby incorporated herein by reference in its entirety.

### TECHNICAL FIELD

The present invention relates to fiber optics and planar lightwave circuits PLCs). More particularly, the present invention relates to a technique for precise alignment and attachment of fiber optics to PLCs in unique, non-linear patterns.

### BACKGROUND OF THE INVENTION

Fiber optic communication networks employ passive and optical components for many functions, and these components are often formed from planar lightwave circuits (PLCs) placed within fiber networks.

PLCs are usually planar, wafer-based modules formed using various silicon-based semiconductor formation techniques including growth, deposition and etching. The upper layers of PLCs employ waveguides (e.g., silica-on-silicon), deposited and etched, for carrying the optical signals within the PLC.

For effective use in fiber optic systems, the PLC waveguides must be interfaced to fiber optics, which carry the optical signals to and from PLCs. Fiber array units (FAUs) are typically employed to interface waveguides terminating at the edge surfaces of PLCs to fiber optic cables. In FAUs, fiber optics are placed in grooves formed (e.g., etched) in a bottom substrate, which terminate at the at a side surface of the substrate in a precise pattern and spacing. A lid is then typically placed over the fiber/grooved-substrate combination, and attached thereto to permanently affix the fibers in the FAU grooves. The fibers are then cut at the FAU's side surface, to form a precise pattern of exposed fiber optics on the FAU side surface, matching an expected pattern of waveguides terminating at a side surface of the PLC. The FAU and PLC are then attached using a suitable attachment technique, whereby the exposed ends of the fibers on the side surface of the FAU mate with the corresponding exposed ends of the waveguides on the side surface of the PLC.

Conventionally, both PLC and FAU structures are highly planar, resulting in an entirely linear or co-planar positioning of waveguides and fibers, respectively. This linear, co-planar arrangement of fibers has been a “rigid” part of PLC and FAU manufacturing for many years, mainly because of the well-developed planar deposition and etching techniques used to form PLCs. Enhanced positional relationships of the waveguides and fibers, however, can offer improvements in density and functionality.

What is required, therefore, are improved techniques for arranging the pattern of waveguides in a PLC, and the corresponding pattern of fibers in an FAU, to enhance the flexibility and functionality of PLCs in optical networks.

### SUMMARY OF THE INVENTION

The shortcomings of the prior art are addressed, and additional advantages are provided by the present invention which in one aspect is a fiber array unit (FAU), for use with a planar waveguide circuit (PLC). The FAU includes a substrate, and a plurality of optical signal transmission channels disposed within the substrate and terminating at a side surface of the substrate for transmitting signals to and/or from the PLC. The channels terminate at a side surface of the substrate in a non-linear, cross-sectional pattern.

The substrate includes a plurality of grooves for holding the plurality of optical signal transmission channels in the non-linear pattern.

A lid may be affixed over the substrate and the optical transmission channels, and may also include a plurality of grooves on a surface thereof terminating at a side surface thereof, in a non-linear cross-sectional pattern, inverse to the pattern in the substrate, to thereby rigidly hold the plurality of optical signal transmission channels in place in cooperation with the substrate.

The optical transmission channels may be fiber optics, and the non-linear pattern may be a curved pattern.

The FAU may be provided in combination with the PLC, the side surface of the FAU attached to a side surface of the PLC, wherein the ends of each optical transmission channel along the side surface of the substrate are aligned to respective transmission waveguides of the PLC, terminating at the side surface of the PLC.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter regarded as the invention is particularly pointed out and distinctly claimed at the conclusion of the specification. The foregoing and other objects, features, and advantages of the invention are apparent from the following detailed description taken in combination with the accompanying drawings in which:

FIG. 1 is a schematic view of a planar waveguide circuit (PLC) coupled to a fiber array unit (FAU) formed in accordance with the principles of the present invention;

FIG. 2A is a cross-sectional view of a typical FAU taken along line 2-2 of FIG. 1; and

FIG. 2B is another cross-sectional view of an improved embodiment of an FAU according to the principles of the present invention; and

FIG. 2C is another cross-sectional view of another improved embodiment of an FAU according to the principles of the present invention.

### DETAILED DESCRIPTION OF THE INVENTION

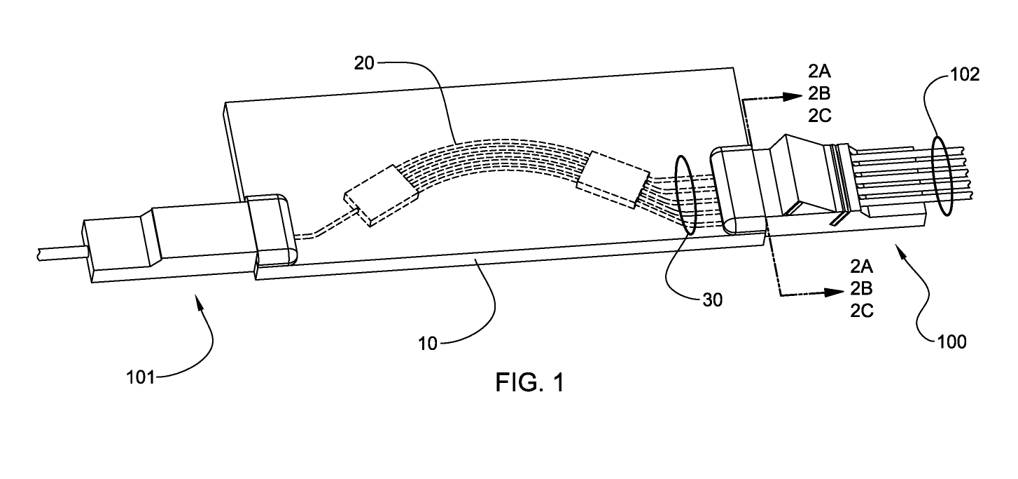

With reference to FIG. 1, a typical planar waveguide circuit (PLC) 10 is shown, which in this example implements an exemplary arrayed waveguide grating (AWG) 20, with input and/or output waveguides 30 running toward the edge of the PLC. (AWGs are known in the art, along with many other optical waveguide circuits that could be implemented within PLC 10, and to which the present invention can be directed.)

Fiber Array Units (FAUs) 100 and 101 are attached to side surfaces of PLC 10, and include optical signal transmission channels 102 for carrying optical signals to and/or from the waveguides 30 of PLC 10. Exemplary embodiments of transmission channels include fiber optics, placed in trenches or grooves defined within the FAU. Exemplary FAUs are disclosed in the commonly-assigned, co-pending U.S. patent applications entitled FIBER ARRAY UNIT WITH INTEGRATED OPTICAL POWER MONITOR; Ser. No. 60/949,259 filed Jul. 12, 2007 and Ser. No. 12/171,488 filed Jul. 11, 2008, the entirety of which are incorporated herein by reference.

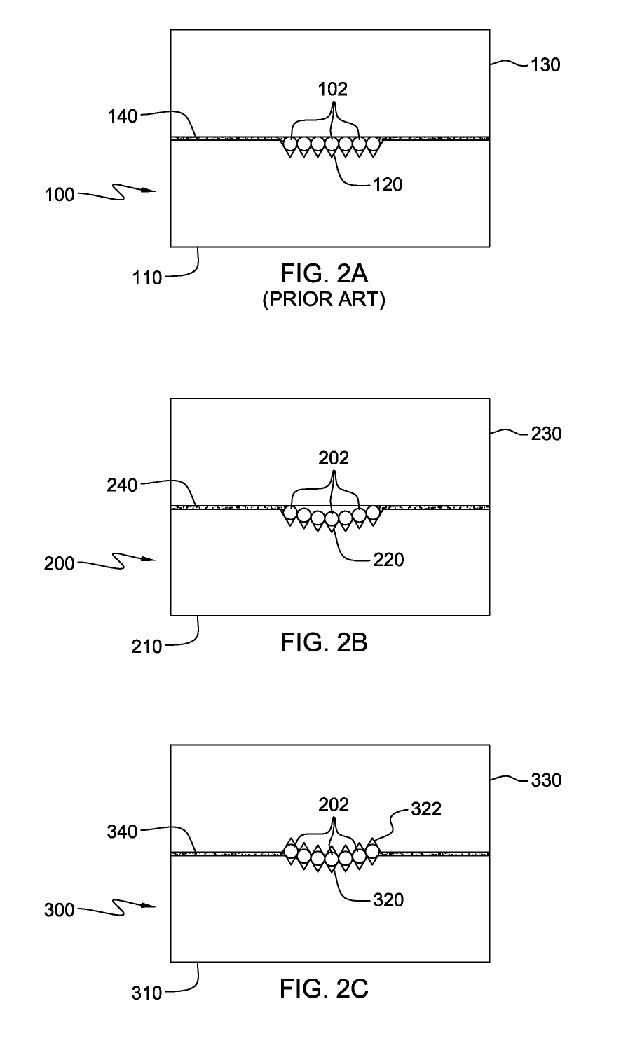

With reference to the cross-sectional view of FIG. 2A taken along line 2-2 of FIG. 1, a typical, prior art FAU 100 includes a substrate 110, the upper surface of which contains a typical linear, co-planar v-groove array 120 formed to hold fibers 102. A lid 130 is disposed over the substrate/fiber combination, and permanently affixed using an adhesive 140. This combination is then ready to be affixed to a PLC (not shown) having a complimentary, linear, co-planar pattern of waveguides at a side surface thereof, which will precisely mate to fibers 102.

With reference to the cross-sectional view of FIG. 2B, an improved embodiment of an FAU 200 includes a substrate 210 into which a non-linear, non-co-planar v-groove array 220 is formed to hold fibers 202. A flat lid 230 is disposed over the substrate/fiber combination, and permanently affixed using an adhesive 240. This combination is then ready to be affixed to a PLC (not shown) having a complimentary, non-linear, non-co-planar pattern of waveguides at a side surface thereof, which will precisely mate to fibers 202. Here the non-linear or non-co-planar cross-sectional pattern of fibers is in the shape of a gentle curve, but those skilled in the art will recognize that any non-linear, or non-co-planar pattern can be employed, without departing from the principles of the present invention.

The use of the flat lid 230 of FIG. 2B requires controlling the adhesive volume 240 over the fibers 202 to realize and predictably maintain the required non-linear, or non-co-planar fiber pattern. This can lead to poor fiber location control, longer process time and low manufacturing yield.

With reference to the cross-sectional view of FIG. 2C, another improved embodiment of an FAU 300 includes a substrate 310 into which a non-linear, non-co-planar v-groove array 320 is formed to hold fibers 302. In contrast to the flat lids of FIGS. 2A-2B, here lid 330 has a plurality of v-grooves formed therein, having a cross-sectional pattern inverse to the pattern of grooves in substrate 310. Lid 330 is disposed over, and aligned to, the substrate/fiber combination, and permanently affixed using an adhesive 340. This combination is then ready to be affixed to a PLC (not shown) having a complimentary, non-linear, non-co-planar pattern of waveguides at a side surface thereof, which will precisely mate to fibers 302.

Here (as in FIG. 2B) the non-linear or non-co-planar cross-sectional pattern of fibers is in the shape of a gentle curve, but those skilled in the art will recognize that any non-linear, or non-co-planar pattern can be employed, without departing from the principles of the present invention.

In the embodiment of FIG. 2C, because the lid 330 has an inverse, non-linear cross-sectional pattern of grooves formed in the lid itself, the lid completes the function of rigidly holding the fibers in place, with only the typical, thin layer of adhesive 240 affixing the lid to the substrate. Therefore, the rigid substrate/lid combination (each made from, e.g., glass, quartz, ceramic, etc.) can rigidly and permanently support the non-linear, or non-co-planar arrangement of fibers, without the errors that may be introduced by an over-reliance on a curable adhesive.

The term “groove” is used broadly herein to connote any type of cavity structure within a substrate suitable for holding an elongated fiber in place including, without limitation, v-grooves, u-grooves, rectangular grooves, trenches, through-tubes, or any similar structures.

Enhanced positional relationships of the waveguides and fibers positioned according to the principles of the present invention offer improvements in density and functionality.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A fiber array unit (FAU), for use with a planar waveguide circuit (PLC), comprising:
a substrate;
a plurality of optical signal transmission channels disposed within the substrate, and terminating at a side surface of the substrate for transmitting signals to and/or from the PLC;
wherein the channels terminate at the side surface of the substrate in a cross-sectional pattern, the cross-sectional pattern being non-linear.

2. The FAU of claim 1, wherein the substrate includes a plurality of grooves for holding the plurality of optical signal transmission channels in the non-linear pattern.

3. The FAU of claim 2, further comprising:
a lid, affixed over the substrate and the optical transmission channels.

4. The FAU of claim 3, wherein the lid includes a plurality of grooves on a surface thereof terminating at a side surface thereof, in a non-linear cross-sectional pattern, inverse to the pattern in the substrate, to thereby rigidly hold the plurality of optical signal transmission channels in place in cooperation with the substrate.

5. The FAU of claim 1, wherein each optical transmission channel comprises a fiber optic disposed in the substrate.

6. The FAU of claim 1, wherein the non-linear pattern comprises a curved pattern.

7. The FAU of claim 1, in combination with the PLC, the side surface of the FAU attached to a side surface of the PLC, wherein the ends of each optical transmission channel along the side surface of the substrate are aligned to respective transmission waveguides of the PLC, terminating at the side surface of the PLC.

8. A method for forming a fiber array unit (FAU), for use with a planar waveguide circuit (PLC), comprising:
providing a substrate;
forming a plurality of optical signal transmission channels within the substrate, and terminating at a side surface of the substrate for transmitting signals to and/or from the PLC;
wherein the channels terminate at the side surface of the substrate in a cross-sectional pattern, the cross-sectional pattern being non-linear.

9. The method of claim 8, wherein the substrate includes a plurality of grooves for holding the plurality of optical signal transmission channels in the non-linear pattern.

10. The method of claim 9, further comprising:
affixing a lid over the substrate and the optical transmission channels.

11. The FAU of claim 10, wherein the lid includes a plurality of grooves on a surface thereof terminating at a side surface thereof, in a non-linear cross-sectional pattern, inverse to the pattern in the substrate, to thereby rigidly hold the plurality of optical signal transmission channels in place in cooperation with the substrate.

12. The method of claim 8, wherein each optical transmission channel comprises a fiber optic disposed in the substrate.

13. The method of claim 8, wherein the non-linear pattern comprises a curved pattern.

14. The method of claim 8, further comprising:
providing the PLC, the side surface of the FAU attached to a side surface of the PLC, wherein the ends of each optical transmission channel along the side surface of the substrate are aligned to respective transmission waveguides of the PLC, terminating at the side surface of the PLC.
